(19) United States
(12) Patent Application Publication
(10) Pub. No.: US 2025/0200126 A1
(43) Pub. Date: Jun. 19, 2025

(54) PDF PAGE RENDERING CACHING METHOD

(71) Applicant: Fujian Foxit Software Development Joint Stock Co., Ltd., Fuzhou City (CN)

(72) Inventor: Junyi LIANG, Fuzhou City (CN)

(21) Appl. No.: 18/834,714

(22) PCT Filed: Aug. 9, 2023
(86) PCT No.: PCT/CN2023/111980

§ 371 Date: Jul. 31, 2024

(30) Foreign Application Priority Data
Sep. 6, 2022 (CN) 202211085881.2

(51) Int. Cl. G06F 16/957; G06F 40/106

(52) U.S. Cl. CPC G06F 16/9574; G06F 40/106

(57) ABSTRACT

Disclosed in the present invention is a PDF page rendering caching method. The method comprises: S1, uniformly dividing an entire PDF page into a plurality of fixed blocks; S2, when the page is first loaded, performing first rendering on a portion to be displayed, and if the width of a rendering result region intersecting any fixed block is equal to the width of the corresponding fixed block, adding a rendering result in the fixed block to a cache list of the fixed block; S3, when the page needs to be rendered again, traversing and checking a cache list stored in each fixed block, and if there is an intersection region with a cached region, rendering a region outside the intersection region, and splicing the current rendered region and the intersection region to output a current rendering result; S4, if the width of the rendered region in S3 intersecting any fixed block is equal to the width of the corresponding fixed block, adding a rendering result in the fixed block to a cache list of the fixed block; and S5, repeating S3 and S4 until the rendering is ended.

### TECHNICAL FIELD

The present invention relates to the technical field of PDF page rendering and caching, in particular to a PDF page rendering and caching method.

### BACKGROUND

In many upper-layer applications, the rendering of documents such as design drawings and engineering drawings is slow, and a rendered region needs to be rendered again when it is displayed again, resulting in repeated time consumption. For example, when browsing a PDF page, if the display content of the page is larger than the display region of the window, in order to see other content, it is necessary to move the page through the scroll bar to view the content of the PDF page. At this time, a PDF browsing application needs to invoke a render function to re-render some PDF objects in the window. For some files, the PDF objects are complex, and it takes more time to render the complex PDF objects, thereby resulting in unsmooth display and stuttering when browsing the PDF page.

An Adobe Acrobat application (Portable Document Format (PDF) editing software developed by Adobe) is also slow during first rendering, so the application will cache a result of the rendered region, and the rate will increase when the region is displayed again, but too much caching will also affect the efficiency of re-rendering. Therefore, how to render and cache a PDF page to improve the refresh efficiency when browsing the PDF page and reduce the occurrence of stuttering is a problem that those skilled in the art want to solve.

### SUMMARY

In order to solve the above problem, the present invention provides a PDF page rendering and caching method. By evaluating whether a result of PDF page rendering needs to be cached, if an image of a corresponding region is cached, the cached image may be used for automatic splicing in the subsequent screen refresh process, to greatly increase the screen refresh speed when the rendered content is displayed again.

In order to achieve the above objective, the present invention provides a PDF page rendering and caching method, which includes:
Step S1, uniformly dividing an entire PDF page into a plurality of fixed blocks;
Step S2, when the page is loaded for the first time, performing first rendering on a portion to be displayed, and comparing a rendering result region with each fixed block capable of intersecting with the rendering result region, if the width of an intersecting region between the rendering result region and any fixed block is equal to the width of a corresponding fixed block, adding a rendering result in the fixed block to a cache list of the fixed block;
Step S3, when the page needs to be rendered again, traversing and checking a cache list stored in each fixed block, if there is an intersecting region between a region to be rendered and a cached region, invoking a render function to render regions except the intersecting region, and splicing the current rendered region and the intersecting region to output a current rendering result;
Step S4, checking the region rendered in step S3 and each fixed block capable of intersecting with the region, if the width of the intersecting region between the region rendered in step S3 and any fixed block is equal to the width of a corresponding fixed block, adding a rendering result in the fixed block to a cache list of the fixed block; and
Step S5, repeating steps S3 and S4 until rendering is ended.

In an embodiment of the present invention, wherein splicing the current rendered region and the intersecting region in step S2 is performed specifically using a Bitmap Transform method.

In an embodiment of the present invention, wherein the update logic of the cache list is specifically as follows:
use “resolution+rotation angle” in all cached rendered regions as a grouping identifier of a first dimension, and for a set of cached data with the same resolution and rotation angle, use “rendering time” as a grouping identifier of a second dimension; and
set a threshold in the cache pool, when the size of the overall data in the cache pool reaches the threshold or when a cache of a specified size to be released is set on an application layer, release first according to the grouping identifier of the first dimension in conjunction with the LRU principle, if the current cached rendered regions all have the same resolution and rotation angle, release the rendered region with the smallest time consumption first according to the rendering time of each rendered region, wherein the rendering time is the time it takes for the region to be rendered from the beginning to the end.

In an embodiment of the present invention, wherein the plurality of fixed blocks are nine fixed blocks, which are distributed in the form of a nine-square grid.

Compared with the prior art, the PDF page rendering and caching method provided by the present invention can improve the efficiency of rendering PDF pages by judging the rendering region that needs to be cached for each fixed block to reduce the size of the page region that needs to be rendered subsequently, thereby reducing the occurrence of stuttering when browsing PDF pages.

### BRIEF DESCRIPTION OF THE DRAWINGS

In order to explain the technical solutions in the embodiments of the present invention or the prior art more clearly, the drawings to be used in the description of the embodiments or the prior art will be briefly introduced below. Obviously, the drawings in the following description show merely some embodiments of the present invention. Those of ordinary skill in the art may obtain other drawings based on these drawings without creative efforts.

FIGS. 1A to 1C are schematic diagrams of an initial solution of an embodiment of the present invention;

FIG. 2 is a schematic diagram of an improved solution of an embodiment of the present invention; and

FIG. 3 is a flow chart of an embodiment of the present invention.

### DETAILED DESCRIPTION

The technical solutions in the embodiments of the present disclosure will be clearly and completely described as below with reference to the accompanying drawings in the embodiments of the present invention. Obviously, the described embodiments are only some of, not all of, the embodiments of the present invention. All other embodiments obtained by a person of ordinary skill in the art based on the embodiments of the present invention without creative effort shall fall into the protection scope of the present disclosure.

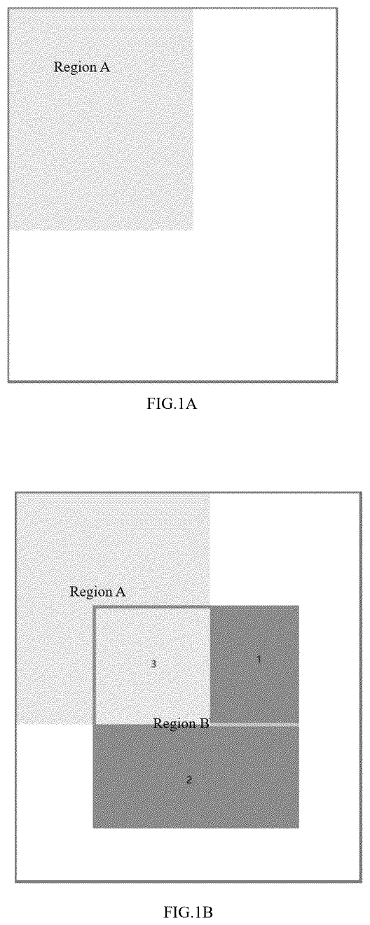

FIGS. 1A to 1C are schematic diagrams of an initial solution of an embodiment of the present invention. As shown in FIGS. 1A to 1C, the initial solution of this embodiment provides a PDF page rendering and caching method. First, cached regions are not fixedly divided, after a PDF page is rendered each time, rendering results on the client (device) are compared with the results in the cache and multiple intersecting regions are found, un-intersecting regions are used as newly rendered regions, and the saved results in the cache are used by the remaining regions to splice a final display result to be rendered currently through a Bitmap Transform (a function that changes the final display result of the original resource image on the client) method. A newly rendered Bitmap needs to be divided and arranged, and then added to the cache list as a new cache object, which specifically includes the following steps:

At S1, first rendering is performed on a PDF page when the cache is empty. Since the cache is empty before the first rendering, the rendering results are added to the cache as one region, that is, region A that is rendered for the first time in FIG. 1A is added to the cache.

At S2, after the page is scrolled, second rendering is performed. Since the cache already contains the region A that is rendered for the first time, a region that needs to be rendered for the second time is different from the region that is rendered for the first time. The region that needs to be rendered for the second time is region B in FIG. 1B. As shown in FIG. 1B, there is an intersecting portion between the region A that is rendered for the first time and the region B that needs to be rendered for the second time, that is, region 3 in the figure. Therefore, when performing second rendering, the intersecting region (region 3) between the region that needs to be rendered for the second time (region B) and the region that is rendered for the first time (region A) is required to be found first, the intersecting region is taken out from the cache (this portion does not need to be rendered again, just read it directly), second rendering is performed on un-intersecting regions (regions 1 and 2), and then the result of this rendering and the taken-out intersecting region are spliced into a second rendering result, that is, entire region B.

At S3, the regions rendered for the second (regions 1 and 2) are arranged and divided into regular rectangular portions (regions 1 and 2), and each divided rectangular portion is added to the cache list as an element.

At S4, after the page is scrolled, third rendering is performed. At this time, the cache already contains region A rendered for the first time and regions 1 and 2 of region B rendered for the second time, and the region rendered for the second time has been divided into two rectangular portions (regions 1 and 2) and saved in the cache list, and the region that needs to be rendered for the third time is region C in FIG. 1C. Therefore, it is necessary to first find out intersecting regions (regions 1, 2 and 3) between the entire region C and all cached regions (region A and region B) in the cache, then take out the intersecting regions (regions 1, 2, and 3) from the cache respectively, and perform third rendering on the un-intersecting portions of the entire region C, and finally splice the rendering result and the intersecting regions (regions 1, 2, and 3) into a third rendering result, that is, the entire region C.

At S5, the regions rendered for the third time are rearranged, and then are regularly divided into several rectangular portions (regions 4 and 5) and added to the cache lists respectively.

At S6, after the page is scrolled, steps S4-S5 are repeated to continue rendering and caching the page.

Since the cache pool is usually limited in size, the cache pool may become full during the process of continuously rendering and caching the rendered regions, so the cache list needs to be updated. In this embodiment, wherein the update logic of the cache list is specifically as follows:
use “resolution+rotation angle” in all cached rendered regions as a grouping identifier of a first dimension, and for a set of cached data with the same resolution and rotation angle, use “rendering time” as a grouping identifier of a second dimension, wherein “resolution+rotation angle” is mainly used to index cached images. For example, for the same page, 100% displayed cached images and 150% displayed cached images are different, and for whether the pages are rotated at a certain angel or pages having different rotation angles, the displayed cached images are also different; and
set a threshold in the cache pool, when the size of the overall data in the cache pool reaches the threshold or when a cache of a specified size to be released is set on an application layer, release first according to the grouping identifier of the first dimension, that is, “resolution+rotation angle” in conjunction with the Least Recently Used (LRU) principle, if the current cached rendered regions all have the same resolution and rotation angle, release the rendered region with the smallest time consumption first according to the rendering time of each rendered region, wherein the rendering time is the time it takes for the region to be rendered from the beginning to the end.

In the aforementioned initial solution, since the cache list is more suitable for storing rectangular regions to facilitate subsequent cache use, when if there are irregular regions in the region that needs to be newly rendered, the irregular regions need to be arranged and divided into regular rectangular regions, and there are two problems in this process of division and arrangement.

On the one hand, when the region that needs to be divided has a relatively complex irregular shape, the dividing process is more complicated, and it is easy to divide particularly small region blocks. Therefore, the implementation process will be more complicated and the overall rendering and caching efficiency will be affected.

On the other hand, since each newly rendered region only needs to be rendered once, it may be difficult to accurately obtain the corresponding region rendering time of each small region when dividing irregular regions. Therefore, when implementing the update logic of the cache list, there may be obstacles that are not easy to implement or inaccurate time consumption, affecting the update of the cache list.

Therefore, the above initial solution is improved to obtain the final solution of this embodiment, that is, the entire page is first divided into a plurality of fixed blocks (for example, in the form of a nine-square grid), and then each fixed block is taken as a smallest unit of cache management, and when the cache list of this fixed block is updated, only the region which intersects with this fixed block and of which the width of the intersecting region is the same as that of a fixed block is saved.

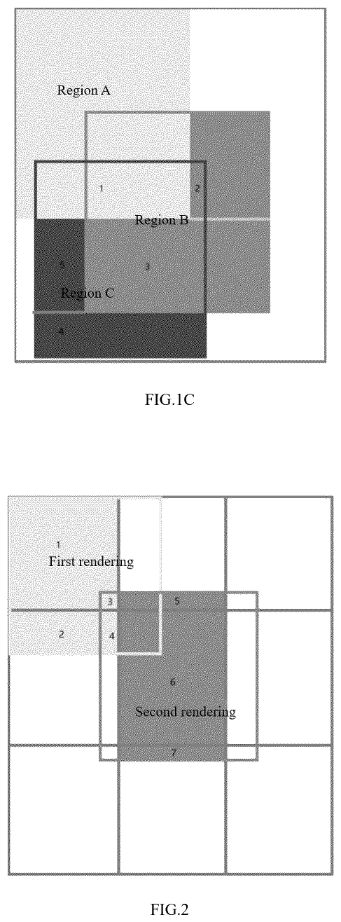

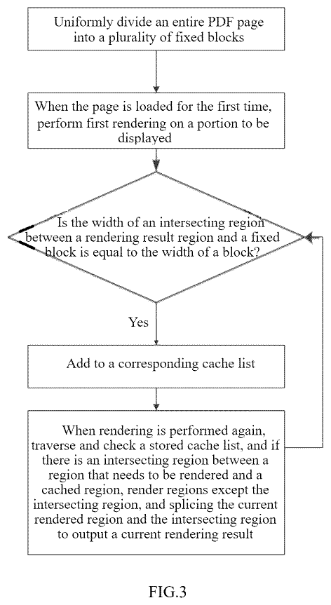

FIG. 2 is a schematic diagram of an improved solution of an embodiment of the present invention. FIG. 3 is a flow chart of an embodiment of the present invention. As shown in FIGS. 2 and 3, this embodiment provides a PDF page rendering and caching method, which specifically includes:

Step S1, uniformly dividing an entire PDF page into a plurality of fixed blocks.

In this embodiment, wherein the plurality of fixed blocks are nine fixed blocks, which are distributed in the form of a nine-square grid. In other embodiments, the PDF page may be uniformly divided into six fixed blocks, eight fixed blocks, etc. The number of uniformly divided fixed blocks is not limited in the present invention.

Step S2, when the page is loaded for the first time, performing first rendering on a portion to be displayed, and comparing a rendering result region with each fixed block capable of intersecting with the rendering result region, if the width of an intersecting region between the rendering result region and any fixed block is equal to the width of a corresponding fixed block, adding a rendering result in the fixed block to a cache list of the fixed block.

As shown in FIG. 2, the region that is rendered for the first time is the region in the light gray box in FIG. 2, which corresponds to the nine fixed blocks divided according to the nine-square grid, the width of the intersecting region (region 1) between the region that is rendered for the first time and the fixed block in the first row and first column is equal to the width of the fixed block, and the width of the intersecting region (region 2) between the region that is rendered for the first time and the fixed block in the second row and first column is also equal to the width of the fixed block, that is, region 1 and region 2 are filled in the entire row, then region 1 and region 2 are added to the cache lists of their respective fixed blocks (the fixed block in the first row and first column and the fixed block in the second row and first column).

Step S3, when the page needs to be rendered again, traversing and checking a cache list stored in each fixed block, if there is an intersecting region between the region that needs to be rendered and a cached region, invoking a render function to render regions except the intersecting region, taking out the intersecting region from a corresponding cache list, and splicing the current rendered region and the intersecting region to output a current rendering result for display in the application.

As shown in FIG. 2, if there is a need to perform second rendering (the region in the dark gray box), the cache lists stored in all fixed blocks are traversed and checked first. It can be found that if there are intersecting regions (regions 3 and 4) between the region that needs to be rendered this time (the region in the dark gray box) and the cached regions (the fixed block in the first row and first column and the fixed block in the second row and first column), then the render function is invoked once to render regions except the intersecting regions (regions 3 and 4). At this time, the data of regions 3 and 4 can be quickly obtained from the cached data of regions 1 and 2, and then the newly rendered region and the intersecting regions (regions 3 and 4) are spliced to output a second rendering result. In this way, the efficiency of the second rendering can be improved.

In this embodiment, wherein splicing the current rendered region and the intersecting region in step S2 is performed specifically using a Bitmap Transform (a function that changes the final display result of the original resource image on the client) method.

Step S4, checking the region rendered in step S3 and each fixed block capable of intersecting with the region, if the width of an intersecting region between the region rendered in step S3 and any fixed block is equal to the width of a corresponding fixed block, adding a rendering result in the fixed block to a cache list of the fixed block.

As shown in FIG. 2, the region that is rendered for the second time intersects with the fixed block in the first row and second column, the fixed block in the second row and second column, and the fixed block in the third row and second column respectively, and the widths of intersecting regions 5, 6 and 7 are equal to the widths of corresponding fixed blocks. Therefore, the rendering results of the regions 5, 6 and 7 in the second rendering are added to the cache lists of their respective fixed blocks (the fixed block in the first row and second column, the fixed block in the second row and second column, and the fixed block in the third row and second column) for subsequent rendering.

Step S5, repeating steps S3 and S4 until rendering is ended.

Since the cache pool is usually limited in size, the cache pool may become full during the process of continuously rendering and caching the rendered regions, so the cache list needs to be updated. In this embodiment, wherein the update logic of the cache list can be the same as that in the initial solution, which is specifically as follows:
use “resolution+rotation angle” in all cached rendered regions as a grouping identifier of a first dimension, and for a set of cached data with the same resolution and rotation angle, use “rendering time” as a grouping identifier of a second dimension; and
set a threshold in the cache pool, when the size of the overall data in the cache pool reaches the threshold or when a cache of a specified size to be released is set on an application layer, release first according to the grouping identifier of the first dimension in conjunction with the LRU principle, if the current cached rendered regions all have the same resolution and rotation angle, release the rendered region with the smallest time consumption first according to the rendering time of each rendered region, wherein the rendering time is the time it takes for the region to be rendered from the beginning to the end.

Compared with the initial solution, the improved solution of this embodiment has the advantages that there is no need to perform a complicated process when updating irregular regions to the cache lists, and because each fixed block is required to be filled in the entire row (that is, the width of the intersecting region of the rendering region is equal to the width of the fixed block) before caching, the cache management of each fixed block is relatively simple.

Compared with the prior art, the PDF page rendering and caching method provided by the present invention can improve the efficiency of rendering PDF pages by judging the rendering region that needs to be cached for each fixed block to reduce the size of the page region that needs to be rendered subsequently, thereby reducing the occurrence of stuttering when browsing PDF pages.

Those of ordinary skill in the art can understand that: the figure is only a schematic diagram of an embodiment, and the modules or processes in the figure are not necessarily necessary for implementing the present invention.

Finally, it should be noted that: the above embodiments are only used for explaining the technical solutions of the present invention rather than limiting the same. Although the present invention is described in detail with reference to the above embodiments, those of ordinary skill in the art should understand that modifications may be made to the technical solutions recorded in the above embodiments, or equivalent replacements may be made to some of the technical features therein. However, these modifications or replacements do not enable the essence of corresponding technical solutions to depart from the spirit and scope of the technical solutions of the embodiments of the present invention.

1. A PDF page rendering and caching method, comprising:
Step S1, uniformly dividing an entire PDF page into a plurality of fixed blocks;
Step S2, when the page is loaded for the first time, performing first rendering on a portion to be displayed, and comparing a rendering result region with each fixed block capable of intersecting with the rendering result region, if the width of an intersecting region between the rendering result region and any fixed block is equal to the width of a corresponding fixed block, adding a rendering result in the fixed block to a cache list of the fixed block;
Step S3, when the page needs to be rendered again, traversing and checking a cache list stored in each fixed block, if there is an intersecting region between a region that needs to be rendered and a cached region, invoking a render function to render regions outside the intersecting region, and splicing the current rendered region and the intersecting region to output a current rendering result;
Step S4: checking the region rendered in step S3 and each fixed block capable of intersecting with the region, if the width of an intersecting region between the region rendered in step S3 and any fixed block is equal to the width of a corresponding fixed block, adding a rendering result in the fixed block to a cache list of the fixed block; and
Step S5, repeating steps S3 and S4 until rendering is ended.

2. The PDF page rendering and caching method according to claim 1, wherein splicing the current rendered region and the intersecting region in step S2 is performed specifically using a bitmap Transform method.

3. The PDF page rendering and caching method according to claim 1, wherein the update logic of the cache list is specifically as follows:
use “resolution+rotation angle” in all cached rendered regions as a grouping identifier of a first dimension, and for a set of cached data with the same resolution and rotation angle, use “rendering time” as a grouping identifier of a second dimension; and
set a threshold in a cache pool, when the size of the overall data in the cache pool reaches the threshold or when a cache of a specified size to be released is set on an application layer, the release first according to the grouping identifier of the first dimension in conjunction with the LRU principle, if the current cached rendered regions all have the same resolution and rotation angle, release the rendered region with the smallest time consumption first according to the rendering time of each rendered region, wherein the rendering time is the time it takes for the region to be rendered from the beginning to the end.

4. The PDF page rendering and caching method according to claim 1, wherein the plurality of fixed blocks are nine fixed blocks, which are distributed in the form of a nine-square grid.
